(19) United States
(12) Patent Application Publication
(10) Pub. No.: US 2009/0256315 A1
(43) Pub. Date: Oct. 15, 2009

(54) SEALING DEVICE

(75) Inventor: Kokichi HAMAMOTO, Fukushima-shi (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/420,388

(22) Filed: Apr. 8, 2009

(30) Foreign Application Priority Data
Apr. 15, 2008 (JP) 2008-105378

(51) Int. Cl. F02F 11/00

(52) U.S. Cl. 277/502

(57) ABSTRACT

To provide a sealing device in which a spring retainer portion integrally provided on a metal ring is neither worn away nor damaged, whereby it is made possible to achieve an easy production and a cost reduction, a sealing device is constructed by a cylindrical metal ring, a seal lip provided on one end of the metal ring and made of a rubber-like elastic material, a spring retainer portion provided on the other end of the metal ring, and a spring seated on the spring retainer portion, and the spring retainer portion is provided with an engaging means for preventing a rotating motion of the spring.

### BACKGROUND OF THE INVENTION

1. Field of the Invention

The present invention relates to a sealing device, and more particularly to a sealing device provided with a spring retainer portion.

2. Description of the Conventional Art

Conventionally, there has been known a valve stem seal as one kind of a lip seal provided with a metal ring, and the valve stem seal is broadly classified into a spring retainer integrated type valve stem seal, and a spring retainer separated type valve stem seal.

As shown in FIG. 4, the spring retainer integrated type valve stem seal is structured such that a seal lip 20 is integrally fixed to one end of a metal ring 10 by baking, and a spring retainer portion 30 for receiving a spring (a valve spring) 40 is provided on the other end of the metal ring 10.

However, in accordance with the former spring retainer integrated type valve stem seal, since it is necessary to apply a hardening process to the spring retainer portion 30 of the metal ring 10 in spite that it is possible to reduce a total number of parts, it takes a lot of man hour and time to produce the metal ring 10, and there is a disadvantage of a cost increase.

Further, if the metal ring 10 is made too hard, there is a risk that the metal ring 10 is cracked by a rubber mold at a time of forming the seal lip 20, and there has been a restriction for increasing a hardness.

Further, there has been known that the spring 40 minutely rotates in accordance with a reciprocating motion of the stem.

Then, since the spring 40 comes into contact with the spring retainer 30 in a high load state, the spring retainer portion 30 is worn away in an early stage due to minute rotation of when the spring 40, thereby leading to a risk of breakage.

Further, in order to solve the problem mentioned above, there has been proposed a configuration that the spring retainer portion 30 is provided separately from the metal ring 10, as shown in FIG. 5.

However, since it is necessary to prepare the spring retainer portion 30 separately from the metal ring 10, it takes a lot of man hour and time to produce the device, and there is a disadvantage of a cost increase.

Reference is made to Japanese Unexamined Patent Publication No. 2003-343734 and Japanese Unexamined Patent Publication No. 2004-176881.

### SUMMARY OF THE INVENTION

### Problem to be Solved by the Invention

The present invention is made by taking the points mentioned above into consideration, and an object of the present invention is to provide a sealing device in which a spring retainer portion is neither worn away nor damaged, whereby it is possible to achieve an easy production and a cost reduction, in accordance with a configuration that the spring retainer portion is integrally provided on a metal ring.

### Means for Solving the Problem

In accordance with the present invention, there is provided a sealing device comprising:

a cylindrical metal ring;

a seal lip provided on one end of the metal ring and made of a rubber-like elastic material;

a spring retainer portion provided on the other end of the metal ring; and

a spring seated on the spring retainer portion,
wherein the spring retainer portion is provided with an engaging means for preventing a rotating motion of the spring.

### Effect of the Invention

The present invention achieves an effect as described below.

In accordance with a first aspect of the sealing device of the present invention, the spring retainer portion is neither worn away nor damaged without necessity of increasing the hardness of the spring retainer portion so much, whereby it is possible to achieve an easy production and a cost reduction, in the configuration that the spring retainer portion is integrally provided on the metal ring.

Further, in accordance with a second aspect of the sealing device of the present invention, since it is possible to prevent a minute rotation of the spring, it is possible to effectively prevent wear and damage of the spring retainer portion by the spring.

Further, in accordance with a third aspect of the sealing device of the present invention, it is possible to maintain a secure engagement between the spring and the spring retainer portion, even in a high load state.

Further, in accordance with a fourth aspect of the sealing device of the present invention, since it is possible to securely prevent the minute rotation of the spring, it is possible to prevent wear of the spring retainer portion by the spring.

Further, in accordance with a fifth aspect of the sealing device of the present invention, it is possible to securely prevent the minute rotation of the spring without deteriorating the function of the spring.

Further, in accordance with a sixth aspect of the sealing device of the present invention, the device is effectively used particularly as a valve stem seal.

### BRIEF EXPLANATION OF DRAWINGS

FIG. 1 is a side view of a sealing device in accordance with the present invention;

FIG. 2 is a partly enlarged perspective view of a metal ring in FIG. 1;

FIG. 3 is a side view of a sealing device in accordance with another embodiment of the present invention;

FIG. 4 is a sectional view of a sealing device in accordance with a conventional art; and

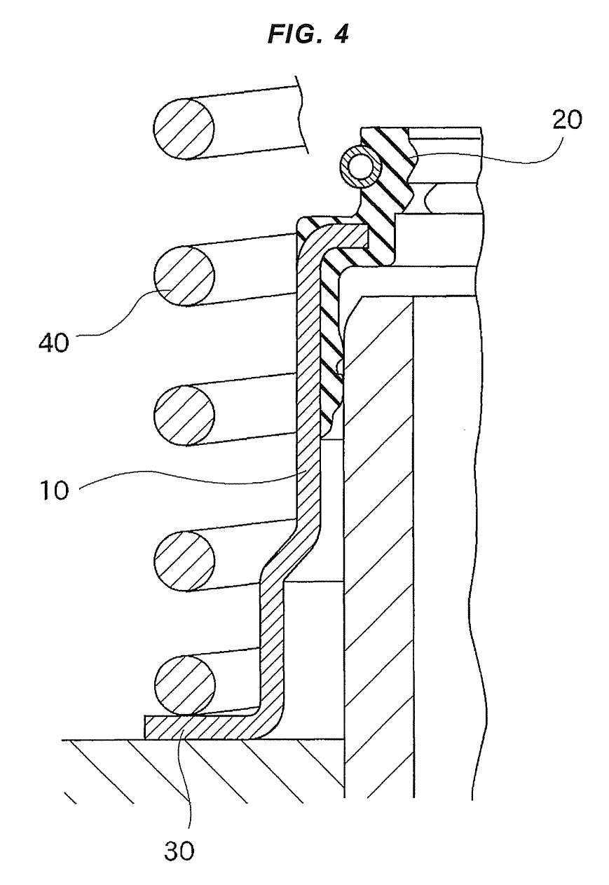

FIG. 5 is a sectional view of another sealing device in accordance with the conventional art.

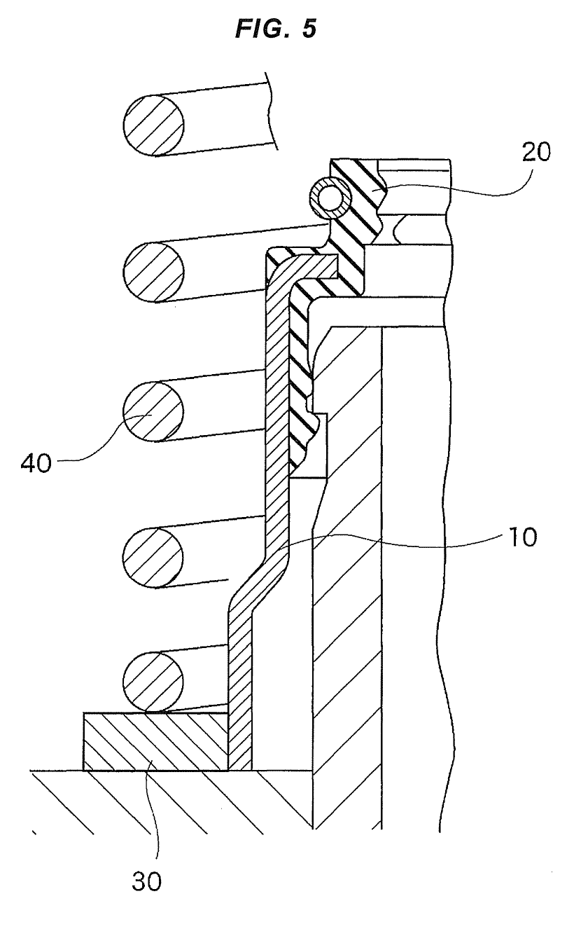

### DETAILED DESCRIPTION OF PREFERRED EMBODIMENT

A description will be given below of preferred embodiments for carrying out the present invention.

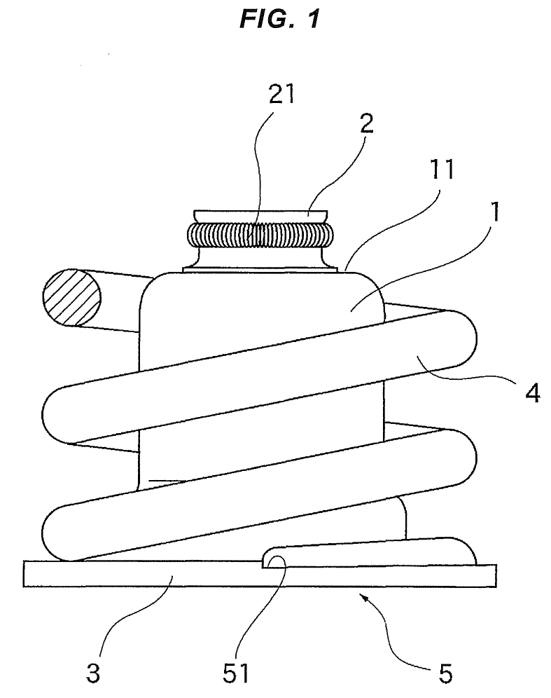

A description will be given of the preferred embodiments for carrying out the invention on the basis of FIGS. 1 to 3.

FIG. 1 is a side view of a sealing device in accordance with the present invention.

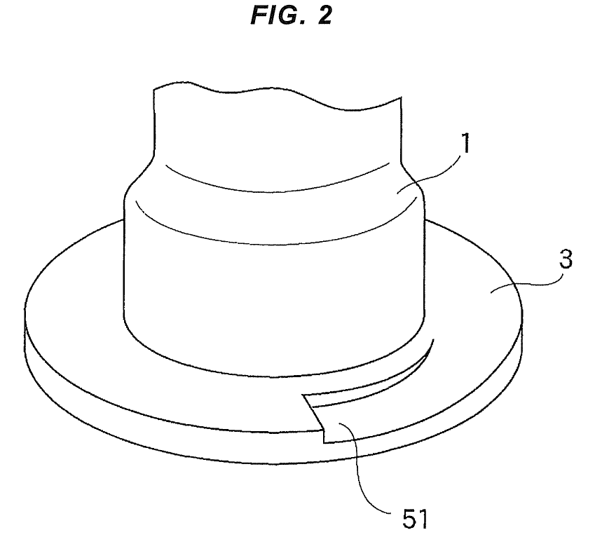

FIG. 2 is a partly enlarged perspective view of a metal ring in FIG. 1.

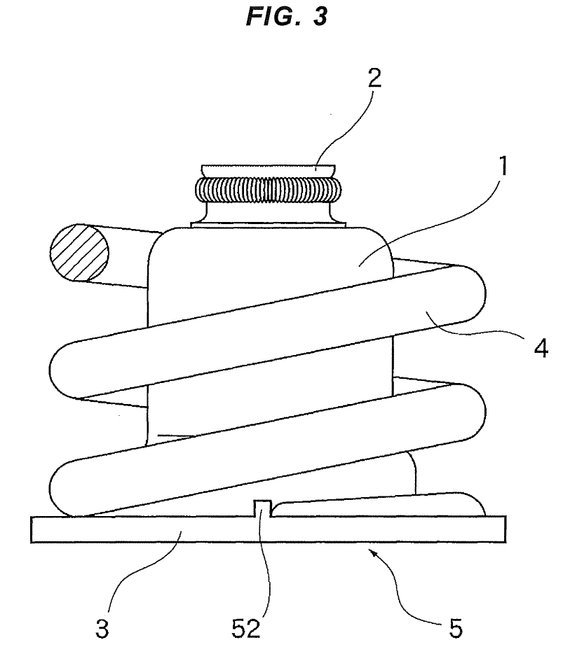

FIG. 3 is a side view of a sealing device in accordance with another embodiment of the present invention.

In FIGS. 1 and 2, the sealing device in accordance with the present invention is constructed by a cylindrical metal ring 1, a seal lip 2 provided on one end of the metal ring 1 and made of a rubber-like elastic material, a spring retainer portion 3 provided on the other end of the metal ring 1, and a spring 4 seated on the spring retainer portion 3.

The seal lip 2 is a valve stem seal, and slidably comes into close contact with an outer peripheral surface of a valve stem (not shown).

Then, in order to adjust close contact force of the seal lip 2 with the valve stem, a coil spring 21 is arranged on an outer peripheral surface of the seal lip 2.

Further, the seal lip 2 is integrally formed on one end (an upper side in the drawing) of the metal ring 1 to which a hardening treatment is applied, in accordance with a vulcanization bonding.

Further, the cylindrical metal ring 1 is produced from a plate-like steel plate in accordance with a press forming or the like, and thereafter subjected to a hardening treatment.

Then, an annular flange 11 extending to an inner side in a radial direction for bonding the seal lip 2 by vulcanization is formed on one end (the upper side in the drawing) of the metal ring 1, and a spring retainer portion 3 extending to an outer side in the radial direction is formed on the other end (a lower side in the drawing) of the metal ring 1.

Further, the spring retainer portion 3 is provided with an engaging means 5 for preventing a rotating motion of the spring 4.

The engaging means 5 is structured, as shown in FIG. 2, such that one end of the spring 4 is fitted to a groove 51 provided in the spring retainer portion 3.

In particular, the groove 51 is a taper groove which becomes deeper little by little in a peripheral direction, as shown in FIG. 2, and one end of the spring 4 has a corresponding shape to be fitted in the taper groove.

Accordingly, it is possible to stably receive a high load even if the high load is applied to the spring 4, and it is possible to securely prevent the minute rotation of the spring 4 caused in consequence of the reciprocating motion of the stem.

Next, a description will be given of a sealing device in accordance with another embodiment of the present invention on the basis of FIG. 3.

The engaging means 5 in the present embodiment is structured such that a projection 52 provided on the spring retainer portion 3 comes into contact with one end of the spring 4.

Then, a height of the projection 52 is such a height that the projection does not come into contact with the peripheral surface of the spring 4 even in a state in which the spring 4 is constricted.

Further, the present invention is, of course, not limited to the preferred embodiments for carrying out the present invention mentioned above, but can employ other various structures without deviating from the substance of the present invention.

What is claimed is:

1. A sealing device comprising:
a cylindrical metal ring;
a seal lip provided on one end of said metal ring and made of a rubber-like elastic material;
a spring retainer portion provided on the other end of said metal ring; and
a spring seated on said spring retainer portion,
wherein said spring retainer portion is provided with an engaging means for preventing a rotating motion of said spring.

2. A sealing device as claimed in claim 1, wherein said engaging means is structured such that one end of said spring is fitted to a groove provided in said spring retainer portion.

3. A sealing device as claimed in claim 2, wherein said groove is a taper groove which becomes deeper little by little in a peripheral direction, and one end of said spring has a corresponding shape to said taper groove.

4. A sealing device as claimed in claim 1, wherein said engaging means is structured such that a projection provided on said spring retainer portion comes into contact with one end of said spring.

5. A sealing device as claimed in claim 4, wherein a height of said projection is such a height that the projection does not come into contact with the peripheral surface of said spring even in a state in which said spring is constricted.

6. A sealing device as claimed in claim 1, wherein said seal lip is a valve stem seal.

7. A sealing device as claimed in claim 2, wherein said seal lip is a valve stem seal.

8. A sealing device as claimed in claim 3, wherein said seal lip is a valve stem seal.

9. A sealing device as claimed in claim 4, wherein said seal lip is a valve stem seal.

10. A sealing device as claimed in claim 5, wherein said seal lip is a valve stem seal.
